(19) United States
(12) Patent Application Publication
(10) Pub. No.: US 2025/0260050 A1
(43) Pub. Date: Aug. 14, 2025

(54) ELECTROLYTE FOR SECONDARY BATTERY AND SECONDARY BATTERY INCLUDING THE SAME

(71) Applicant: SK ON CO., LTD., Seoul (KR)

(72) Inventor: Jae Hoon CHOI, Daejeon (KR)

(21) Appl. No.: 19/023,366

(22) Filed: Jan. 16, 2025

(30) Foreign Application Priority Data
Feb. 13, 2024 (KR) 10-2024-0020315

(51) Int. Cl. H01M 10/0565

(52) U.S. Cl. CPC H01M 10/0565; H01M 2300/0082

(57) ABSTRACT

According to embodiments of the present disclosure, an electrolyte for a secondary battery includes: a polymer matrix; and inorganic particles which contain boron and nitrogen, and have a two-dimensional shape, wherein a content of the inorganic particles is a content of the polymer matrix or more based on the weight. The secondary battery includes a cathode, an anode, and an electrolyte layer which is disposed between the cathode and the anode, and includes the above-described electrolyte for a secondary battery.

### CROSS-REFERENCE TO RELATED APPLICATION(S)

This patent document claims the priority and benefits of Korean Patent Application No. 10-2024-0020315 filed on Feb. 13, 2024, the disclosure of which is incorporated herein by reference in its entirety.

### BACKGROUND OF THE INVENTION

### 1. Field of the Invention

The present disclosure relates to an electrolyte for a secondary battery and a secondary battery including the same.

### 2. Description of the Related Art

A secondary battery is a battery which can be repeatedly charged and discharged. With rapid progress of information and communication, and display industries, the secondary battery has been widely applied to various portable electronic telecommunication devices such as a camcorder, a mobile phone, a laptop computer as a power source thereof. Recently, a battery pack including the secondary battery has also been developed and applied to an eco-friendly automobile such as an electric vehicle, a hybrid vehicle, etc., as a power source thereof.

Examples of the secondary battery may include a lithium secondary battery, a sodium secondary battery, a potassium secondary battery, a calcium secondary battery, a nickel-cadmium battery, a nickel-hydrogen battery and the like. Among them, the lithium secondary battery has a high operating voltage and a high energy density per unit weight, and is advantageous in terms of a charging speed and light weight.

The secondary battery may include a liquid electrolyte as an electrolyte. When using the liquid electrolyte, safety problems such as leakage, explosion, ignition, and the like may occur due to rapid environmental changes such as temperature changes, external impacts, etc. Accordingly, to enhance the stability, a secondary battery including a solid electrolyte in a gel or solid form is being developed. For example, such the secondary battery may include a semi-solid-state battery including an electrolyte having a partial solid form, or an all-solid-state battery including an electrolyte in a completely solid form.

The solid-state battery may include an electrode assembly including a cathode, an anode and an electrolyte layer. The cathode, the anode, and/or the electrolyte layer of the solid-state battery may include a solid electrolyte. As the application range of the solid-state battery expands, longer lifespan, higher capacity, and higher energy density are required.

### SUMMARY OF THE INVENTION

An object of the present disclosure is to provide an electrode for a secondary battery having improved energy density and output characteristics.

Another object of the present disclosure is to provide a secondary battery including the electrode having improved capacity and output characteristics.

To achieve the above objects, according to an aspect of the present disclosure, there is provided an electrolyte for a secondary battery including: a polymer matrix; and inorganic particles which contain boron and nitrogen, and have a two-dimensional shape, wherein a content of the inorganic particles is a content of the polymer matrix or more based on the weight.

In some embodiments, the inorganic particles may have a plate-like shape.

In some embodiments, the inorganic particles may include boron nitride.

In some embodiments, the boron nitride may have a hexagonal crystal structure.

In some embodiments, the inorganic particles may have a length of 50 nm to 400 nm.

In some embodiments, the content of the inorganic particles may be 50% by weight or more based on a total weight of the electrolyte for a secondary battery.

In some embodiments, the content of the inorganic particles may be 60% by weight to 80% by weight based on the total weight of the electrolyte for a secondary battery.

In some embodiments, the polymer matrix may include a fluorine resin or a sulfone resin.

In some embodiments, the content of the polymer matrix may be 10% by weight to 50% by weight based on the total weight of the electrolyte for a secondary battery.

In some embodiments, the polymer matrix may have a porous structure.

In some embodiments, the electrolyte for a secondary battery may further include a liquid electrolyte impregnated in the polymer matrix.

In some embodiments, the liquid electrolyte may include a lithium salt and an organic solvent.

In some embodiments, the electrolyte for a secondary battery may further include a polymer of an acrylate monomer containing a phosphorus (P) atom or a fluorine (F) atom.

In some embodiments, the acrylate monomer may include a phosphazene moiety.

According to another aspect of the present disclosure, there is provided a solid electrolyte layer including the electrolyte for a secondary battery according to the above-described embodiments.

In some embodiments, the solid electrolyte layer may have a film shape or a sheet shape.

In addition, according to another aspect of the present disclosure, there is provided a secondary battery including: a cathode; an anode disposed to face the cathode; and an electrolyte layer which is disposed between the cathode and the anode, and includes the electrolyte for a secondary battery according to the above-described embodiments.

The electrolyte for a secondary battery may include a polymer matrix and inorganic particles containing boron and nitrogen and having a two-dimensional shape. A content of the inorganic particles in the electrolyte for a secondary battery may be a content of the polymer matrix or more. Thermal stability, mechanical properties, and ionic conductivity of the electrolyte for a secondary battery may be improved.

The electrolyte for a secondary battery may include a liquid electrolyte. An additional movement path for ions may be provided in the electrolyte for a secondary battery, thereby further increasing the ionic conductivity.

The secondary battery may include the electrolyte for a secondary battery. The ignition stability, lifespan characteristics, and durability of the secondary battery may be improved, and driving characteristics at a high voltage may be improved.

The secondary battery according to the embodiments of the present disclosure may be widely applied to green technology fields such as an electric vehicle, and a battery charging station, as well as other solar power generation and wind power generation using the batteries. In addition, the secondary battery according to the embodiments of the present disclosure may be used in an eco-friendly electric vehicle, and a hybrid vehicle, etc., which are intended to prevent climate change by suppressing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a schematic cross-sectional view illustrating an electrode cell according to exemplary embodiments;

FIG. 2 is a photographic image obtained by photographing the surface of an electrolyte film for a secondary battery according to Example 1; and

FIG. 3 is a photographic image obtained by photographing the surface of an organic-inorganic film according to Comparative Example 7.

### DETAILED DESCRIPTION OF THE INVENTION

According to the embodiments of the present disclosure, an electrolyte for a secondary battery including a polymer resin and inorganic particles is provided.

According to the embodiments of the present disclosure, a secondary battery including the electrolyte for a secondary battery is provided.

Hereinafter, embodiments of the present disclosure will be described in more detail with reference to the drawings. However, the following drawings attached to the present specification illustrate embodiments of the present disclosure, and serve to further understand the technical spirit of the present disclosure together with the above-described contents of the invention, such that the present disclosure should not be construed as being limited only to the illustrations of the drawings.

The terms “upper surface,” “lower surface,” etc. as used herein are intended to describe the relative positional relationship of the respective components and do not mean an absolute upper-lower relationship.

Hereinafter, unless otherwise defined herein, when a portion such as a layer, film, thin film, region, or plate, etc. is present “on” or “above” another portion, it may include not only the case where the portion is present “directly on” the another portion, but also the case where a further another portion is present in the middle therebetween.

Hereinafter, embodiments of the present disclosure will be described in detail. However, these are merely illustrative and the present disclosure is not limited to the specific embodiments described by way of example.

The electrolyte for a secondary battery may include a polymer matrix and inorganic particles. For example, the inorganic particles may be dispersed in the polymer matrix or supported by the polymer matrix.

The inorganic particles may contain boron and nitrogen. The boron and nitrogen have different electron densities, such that the mobility of metal ions (e.g., lithium ions) on the surface of the inorganic particles may be increased. For example, movement of ions may be promoted by a repulsive force due to asymmetry of an unshared electron pair between the boron and the nitrogen. Accordingly, the inorganic particles may have ionic conductivity, and the ionic conductivity of the electrolyte for a secondary battery may be improved by the inorganic particles.

The inorganic particles may have a two-dimensional shape. The two-dimensional shape may mean a shape in which atoms have a thickness of a single atomic layer and form a crystal structure in a two-dimensional plane. For example, the inorganic particles may have a thickness of 10 nm or less, and may be a two-dimensional material having a graphene-like shape.

Since the inorganic particles have a two-dimensional shape having an atomic-level thickness, an ion transfer path within the inorganic particles may be shortened, thereby improving ion transfer characteristics of the electrolyte for a secondary battery. In addition, the inorganic particles can have high thermal and physical stability, such that heat resistance and mechanical properties of the electrolyte for a secondary battery may be improved.

In some embodiments, the inorganic particles may have a plate-like shape. For example, the inorganic particles may have a shape such as a nano-plate, a nano-flake, or a nano-sheet, etc. Since the inorganic particles have the plate-like shape, an area through which ions can move within the inorganic particles may be increased. Accordingly, the movement path for ions through the surface of the inorganic particles may be increased, and the ionic conductivity may be further improved.

In some embodiments, the inorganic particles may include boron nitride. The boron nitride has a crystal structure composed of nitrogen and boron, such that movement of ions may be further facilitated, and may be thermally and physically stable. Accordingly, the ionic conductivity, heat resistance, and mechanical properties of the electrolyte for a secondary battery may be further improved.

In one embodiment, the boron nitride may include hexagonal boron nitride (hexagonal-BN). For example, the crystal structure of the boron nitride may be composed of a hexagonal arrangement of boron atoms and nitrogen atoms. Accordingly, the boron nitride has electrical insulation characteristics due to a large band gap of about 5.9 eV, and may be more physically and mechanically stable.

The content of the inorganic particles may be the content of the polymer matrix or more based on the weight. For example, the inorganic particles may be a main component or a dominant component of the electrolyte for a secondary battery. Here, the content may be % by weight (“wt %”) based on a sum of the weight of the inorganic particles and the weight of the polymer matrix.

When the content of the inorganic particles is smaller than the content of the polymer matrix, the ionic conductivity and thermal stability of the electrolyte for a secondary battery may be decreased. For example, ionic bonds may be formed between the polymer matrix and the nitrogen and boron of the inorganic particles. Accordingly, an imbalance in electron density of the inorganic particles may be reduced, or the stability according to the crystal structure of the inorganic particles may be decreased. Therefore, when the polymer matrix is included in an excessive amount compared to the inorganic particles, an interaction between the inorganic particles and the polymer matrix may be increased, thereby decreasing the ionic conductivity and thermal stability through the inorganic particles.

In one embodiment, a ratio of the content of the inorganic particles to the content of the polymer matrix may be, based on the weight, greater than 1 and 5 or less, 1.2 to 4.5, 1.5 to 4, or 1.8 to 3.5. Within the above range, the electrochemical stability, processability, and mechanical properties of the electrolyte for a secondary battery may be secured, as well as the heat resistance and ionic conductivity may be further improved.

According to exemplary embodiments, the content of the inorganic particles may be 50 wt % or more based on a total weight of the electrolyte for a secondary battery.

In one embodiment, the content of the inorganic particles may be about 50 wt % to 90 wt %, 60 wt % to 80 wt %, 65 wt % to 80 wt %, or 65 wt % to 75 wt % based on the total weight of the electrolyte for a secondary battery. Within the above range, the leakage and leaching of components in the electrolyte for a secondary battery may be suppressed, and the processability and moldability may be improved, while enhancing the ionic conductivity and flame retardancy of the electrolyte for a secondary battery.

According to some embodiments, the inorganic particles may have a length of 50 nm to 400 nm. The length may be calculated as the longest width of the inorganic particles on a plane. For example, when the length of the inorganic particles is 400 nm or less, ion trapping due to the inorganic particles may be increased, and the ionic conductivity may be improved. For example, when the length of the inorganic particles is 50 nm or more, the stability of the crystal structure may be further improved.

In one embodiment, the inorganic particles may have a length of about 50 nm to 300 nm, about 60 nm to 200 nm, or about 70 nm to 150 nm. Within the above range, the mechanical properties, heat resistance, and ionic conductivity of the electrolyte for a secondary battery may be further improved.

According to exemplary embodiments, the polymer matrix may include a fluorine resin, a sulfone resin, an imide resin and/or a urethane resin. Accordingly, the flame retardancy of the electrolyte for a secondary battery may be improved.

For example, the polymer matrix may include polyvinylidenefluoride (PVdF), vinylidenefluoride-hexafluoropropylene copolymer (PVDF-co-HFP), polychlorotrifluoroethylene (PCTFE), polytetrafluoroethylene (PTFE), polysulfone (PS), polyethersulfone (PES), polyimide (PI), polyurethane (PU), etc. These may be used alone or in combination of two or more thereof.

In one embodiment, the polymer matrix may include a fluorine resin or a sulfone resin. For example, the polymer matrix may include polyvinylidene fluoride, polysulfone, polyethersulfone, etc.

The fluorine resin and the sulfone resin have high compatibility with the inorganic particles, such that the inorganic particles may be more uniformly dispersed in the polymer matrix. In addition, the thermal stability of the polymer matrix may be further improved by the fluorine resin or the sulfone resin.

In some embodiments, the content of the polymer matrix may be 10 wt % to 50 wt % based on the total weight of the electrolyte for a secondary battery. If the content of the polymer matrix is greater than 50 wt %, the heat resistance and ionic conductivity of the electrolyte for a secondary battery may be decreased. If the content of the polymer matrix is less than 10 wt %, the mechanical stability and moldability of the electrolyte for a secondary battery may be decreased.

In one embodiment, the content of the polymer matrix may be about 10 wt % to 45 wt %, about 10 wt % to 40 wt %, about 10 wt % to 35 wt %, 15 wt % to 35 wt %, or 25 wt % to 35 wt % based on the total weight of the electrolyte for a secondary battery. Within the above range, the ionic conductivity and thermal stability may be further enhanced, while further improving the mechanical properties of the electrolyte for a secondary battery.

In some embodiments, the polymer matrix may have a porous structure. For example, the polymer matrix may include a plurality of pores formed on the surface and inside thereof. The inorganic particles and/or the liquid electrolyte may be impregnated and fixed or accommodated in the pores of the polymer matrix. Accordingly, the ionic conductivity may be further increased, while improving the stability of the electrolyte for a secondary battery.

According to exemplary embodiments, the electrolyte for a secondary battery may further include a liquid electrolyte. For example, the liquid electrolyte may be impregnated into the polymer matrix, and the electrolyte for a secondary battery may be a gel polymer electrolyte. The electrolyte for a secondary battery has a gel form, such that electrochemical stability may be improved, and adhesion to other materials such as an electrode active material layer within the secondary battery may be increased.

According to exemplary embodiments, the liquid electrolyte may include a lithium salt and an organic solvent. The mobility of ions may be increased by the lithium salt and the organic solvent.

The lithium salt may be expressed by Li⁺X⁻, for example. As an anion (X⁻) of the lithium salt, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻, etc. may be exemplified.

In some embodiments, the organic solvent may include carbonate solvents such as propylene carbonate (PC), ethylene carbonate (EC), diethyl carbonate (DEC), dimethyl carbonate (DMC), ethyl methyl carbonate (EMC), methyl propyl carbonate (MPC), dipropyl carbonate (DPC) and vinylene carbonate (VC), dimethyl sulfoxide, acetonitrile, dimethoxyethane, diethoxyethane, sulfolane, gamma-butyrolactone, propylene sulfite and tetrahydrofuran, etc. These may be used alone or in combination of two or more thereof.

In one embodiment, the organic solvent may include a carbonate solvent. Accordingly, the electrical stability and chemical stability of the electrolyte for a secondary battery may be further improved.

In one embodiment, the liquid electrolyte may further include an additive. The additive may include, for example, a cyclic carbonate compound, a fluorine-substituted cyclic carbonate compound, a sultone compound, a cyclic sulfate compound, a phosphate compound, a borate compound, etc.

In some embodiments, a content of the liquid electrolyte may be 1 wt % to 10 wt % based on the total weight of the electrolyte for a secondary battery. Within the above range, the chemical and thermal stability may be further improved, while increasing the ionic conductivity of the electrolyte for a secondary battery.

In some embodiments, the electrolyte for a secondary battery may further include a polymer of an acrylate monomer. For example, the liquid electrolyte may include an acrylate monomer. The polymer may be formed by impregnating the liquid electrolyte into the polymer matrix, and curing the acrylate monomer. Polymerizable functional groups (e.g., acrylate groups) of the acrylate monomer may be cross-linked to each other by irradiation with light or heat treatment.

The acrylate monomer may contain a phosphorus (P) atom or a fluorine (F) atom. The phosphorus atom and the fluorine atom may suppress chain ignition, and for example, the polymer may have self-extinguishing properties due to the phosphorus atom and the fluorine atom. Accordingly, the flame retardancy of the electrolyte for a secondary battery may be further improved.

In one embodiment, the acrylate monomer may include a phosphazene moiety. The phosphazene moiety has a high phosphorus content, such that the flame retardancy of the polymer may be further enhanced.

In some embodiments, the liquid electrolyte may include a thermal initiator or a photo-initiator which initiates a polymerization reaction of the acrylate monomer.

For example, the thermal initiator may include azo compounds such as 2,2′-azobis(2-cyanobutane), 2,2′-azobis(methylbutyronitrile), 2,2′-azobis(isobutyronitrile) (AIBN), azobisdimethyl-valeronitrile (AMVN), etc., or peroxide compounds such as benzoyl peroxide, acetyl peroxide, dilauryl peroxide, di-tert-butyl peroxide, cumyl peroxide, hydrogen peroxide, etc.

For example, the photo-initiator may include acyl phosphines such as 2-hydroxy-2-methyl-1-phenylpropan-1-one (HMPP), benzoin ether, dialkyl acetophenone, hydroxyl alkylketone, phenyl glyoxylate, Benzyl Dimethyl Ketal, 2,4,6-trimethyl-benzoyl-trimethyl phosphine oxide, etc., and α-aminoketone.

In one embodiment, the content of the polymer may be about 1 wt % to 15 wt %, or about 3 wt % to 10 wt % based on the total weight of the electrolyte for a secondary battery. Within the above range, the flame retardancy and heat resistance may be further improved, while the electrolyte for a secondary battery has high ionic conductivity.

In some embodiments, the electrolyte for a secondary battery may further include a solid electrolyte. The solid electrolyte may include an oxide-based electrolyte and/or a sulfide-based electrolyte.

In some embodiments, the sulfide-based electrolyte may be an LPS-based solid electrolyte including Li, P and S, an LPSCl-based solid electrolyte including Li, P, S and Cl, an LGPS-based solid electrolyte including Li, P, Ge and S, or an LSiPSCl-based solid electrolyte including Li, Si, P, S and Cl.

For example, as the sulfide-based electrolyte, Li₂S—P₂S₅, Li₁₀GeP₂S₁₂, Li₁₀SnP₂S₁₂, Li_{9.54}Si_{1.74}P_{1.44}S_{11.7}Cl_{0.3}, Li₁₀(Si_{0.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li₁₀GeP₂Sr_{11.7}O_{0.3}, Li_{9.6}P₃S₁₂, Li₉P₃S₉O₃, Li_{10.35}Ge_{1.35}P_{1.65}Si₂, Li_{10.35}Si_{1.35}P_{1.65}S₁₂, Li_{9.81}Sn_{0.81}P_{2.19}S₁₂, Li_{9.42}Si_{1.02}P_{2.1}S_{9.96}O_{2.04}, Li₆PS₅Cl, etc. may be used.

In one embodiment, the sulfide-based electrolyte may include a solid electrolyte having an argyrodite-type crystal structure.

In one embodiment, the oxide-based electrolyte may include an ion conductive compound containing a metal oxide and/or oxygen.

Examples of the metal oxide may include Al₂O₃, ZnO₂, Ce₂O₃, TiO₂, ZrO₂, HfO₂, MnO₂, MgO, WO₂, V₂O₅, etc.

Examples of the ion conductive compound may include garnet compounds such as a LLZO compound, etc.; perovskite compounds such as a LLTO compound, etc.; NASICON compounds such as Li₁₊ₓAlₓGe₂₋ₓ(PO₄)₃ (0<x<2), Li₁₊ₓAlₓTi₂₋ₓ(PO₄)₃ (0<x<2), Li₁₊ₓTi_{2-x-y}AlₓSi_{y}(PO₄)_{3-y} (0≤x≤1, 0≤y≤1), a LAGP compound, a LATP compound, LiAlₓZr₂₋ₓ(PO₄)₃ (0≤x≤1), LiTiₓZr₂₋ₓ(PO₄)₃ (0≤x≤1), etc.; UPON compounds; Li₆La₂CaTa₂O₁₂; Li₆La₂ANb₂O₁₂ (A is Ca or Sr); Examples include Li₂Nd₃TeSbO₁₂, Li₃BO_{2.5}N_{0.5}; Li₉SiAlO₈, etc.

In one embodiment, a content of the solid electrolyte may be 1 wt % to 10 wt %, or 1 wt % to 5 wt % based on the total weight of the electrolyte for a secondary battery.

According to exemplary embodiments, a slurry for forming an electrolyte may be prepared by mixing an organic polymer included in the polymer matrix, inorganic particles, and/or a solid electrolyte in a solvent. The organic polymer may include the above-described fluorine resin, sulfone resin, imide resin, urethane resin, etc.

An electrolyte for a secondary battery including the polymer matrix, the inorganic particles, and/or the solid electrolyte may be prepared by drying the slurry for forming an electrolyte. While the solvent is dried and evaporated, the inorganic particles and/or the solid electrolyte may be uniformly dispersed in the polymer matrix.

For example, the solvent may include tetrahydrofuran (THF), 2-methyltetrahydrofuran (2-Me-THF), N-methyl-2-pyrrolidone (NMP), 1,3-dioxolane, vinylene carbonate (VC), etc. These may be used alone or in combination of two or more thereof.

In one embodiment, the solvent may include different heterogeneous solvents. A polymer matrix having a porous structure may be prepared through drying conditions for the heterogeneous solvents. For example, pores may be formed in the polymer matrix by adjusting a solubility of the organic polymer in the heterogeneous solvent, a boiling point of the heterogeneous solvent, a removal order, etc.

For example, the solvent may include a first solvent and a second solvent which are different from each other. The solubility of the organic polymer in the first solvent may be greater than the solubility of the organic polymer in the second solvent. For example, the organic polymer may be soluble in the first solvent, whereas insoluble in the second solvent. Accordingly, the organic polymer may be selectively dissolved in the first solvent.

A polymer matrix may be formed by removing the first solvent from the slurry for forming an electrolyte. A porous structure may be formed by removing the second solvent from the polymer matrix. For example, pores may be formed in a region where the second solvent is removed. The inorganic particles may be distributed within the pores.

The boiling point of the first solvent may be lower than the boiling point of the second solvent. Therefore, the first solvent and the second solvent may be sequentially removed due to a difference in the boiling point.

In one embodiment, the first solvent may include tetrahydrofuran, 2-methyltetrahydrofuran, N-methyl-2-pyrrolidone, 1,3-dioxolane, vinylene carbonate, etc. In one embodiment, the second solvent may include heptane, octane, nonane, decane, dodecane, 2,2,4-trimethylpentane, etc.

A liquid electrolyte may be impregnated into the polymer matrix having the porous structure. The liquid electrolyte may be impregnated into the pores of the polymer matrix.

In one embodiment, the liquid electrolyte may further include an acrylate monomer containing a phosphorus atom or a fluorine atom. The liquid electrolyte impregnated into the polymer matrix may be irradiated with light, or the liquid electrolyte may be heated. Accordingly, the acrylate monomer may be polymerized within the liquid electrolyte.

An electrolyte layer according to embodiments of the present disclosure may include the electrolyte for a secondary battery according to the above-described embodiments. For example, the electrolyte layer may be a solid electrolyte layer. For example, the electrolyte layer may have a film or sheet shape.

In some embodiments, the electrolyte layer may be disposed between electrodes. While ions may smoothly move between the electrodes through the electrolyte layer, a short circuit between the electrodes may be prevented. For example, the electrolyte layer may be substantially provided as a separation membrane within the secondary battery.

The secondary battery according to embodiments of the present disclosure may include the electrolyte for a secondary battery according to the above-described embodiments.

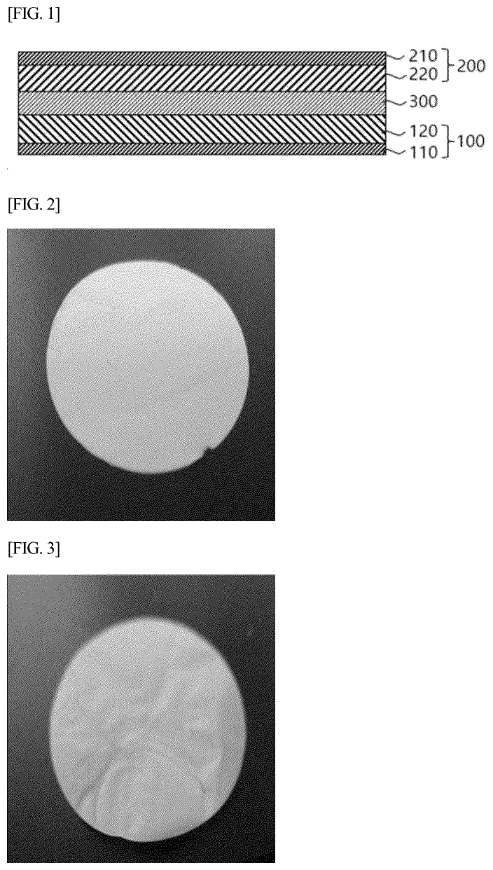

FIG. 1 is a schematic cross-sectional view illustrating an electrode cell according to exemplary embodiments.

Referring to FIG. 1, the electrode cell may include a cathode 100 and an anode 200 disposed to face the cathode 100.

The cathode 100 may include a cathode current collector 110 and a cathode active material layer 120 disposed on at least one surface of the cathode current collector 110. The cathode active material layers 120 may be formed on both surfaces (e.g., upper and lower surfaces) of the cathode current collector 110.

The cathode current collector 110 may include stainless steel, nickel, aluminum, titanium, copper, or an alloy thereof, for example, may include aluminum or an aluminum alloy. In one embodiment, the cathode current collector 110 may include aluminum or stainless steel subjected to surface treatment with carbon, nickel, titanium or silver.

The cathode active material layer 120 may include a cathode active material, a binder, and/or a conductive material. For example, the cathode slurry including the cathode active material, the binder, and/or the conductive material may be applied to the cathode current collector 110, followed by drying and pressing the same to form the cathode active material layer 120.

Examples of the cathode active material may include a lithium iron phosphate compound, a lithium cobalt oxide, a lithium manganese oxide, a lithium nickel oxide or a lithium composite oxide. For example, the secondary battery of the present disclosure may be provided as a lithium secondary battery.

For example, the cathode active material may include a layered compound such as lithium cobalt oxide (LiCoO₂) or lithium nickel oxide (LiNiO₂), etc., or lithium manganese oxide such as LiMnO₃, LiMn₂O₃, and LiMnO₂, etc.; lithium copper oxide (Li₂CuO₂); vanadium oxide such as LiV₃O₈, LiFe₃O₄, V₂O₅ and Cu₂VO₇, etc.; and lithium iron phosphate oxide such as LiFePO₄, etc.

In some embodiments, the cathode active material may include a compound represented by Formula 1 below.

LiₐNi_{b}M_{1-b}O₂ [Formula 1]

In Formula 1, a and b may satisfy 0.95≤a≤1.08, b≥0.5, and M may be at least one element of Na, Mg, Ca, Y, Ti, Zr, Hf, V, Nb, Ta, Cr, Mo, W, Mn, Co, Fe, Cu, Ag, Zn, B, Al, Ga, C, Si, Sn, Ba and Sr.

In one embodiment, the cathode active material may further include at least one of cobalt (Co) or manganese (Mn). For example, a nickel-cobalt-manganese (NCM)-based lithium oxide may be used as the cathode active material.

Nickel (Ni) may be provided as a metal associated with the capacity of the lithium secondary battery. The higher the content of nickel, the better the capacity and output of the lithium secondary battery, but if the content of nickel is excessively increased, it may be disadvantageous in terms of mechanical and electrical stabilities.

The conductivity or resistance of the lithium secondary battery may be improved by cobalt (Co), as well as the mechanical and electrical stabilities of the lithium secondary battery may be improved by manganese (Mn).

The chemical structure represented by Formula 1 shows a bonding relationship between elements included in the lattice structure or crystal structure of the cathode active material, and does not exclude other additional elements. For example, M may be provided as a main active element of the cathode active material. Here, it should be understood that Formula 1 is provided to express the bonding relationship between the main active elements, and is a formula encompassing introduction and substitution of the additional elements.

In one embodiment, the cathode active material may further include auxiliary elements which are added to the main active elements, thus to enhance chemical stability thereof or the crystal structure. The auxiliary element may be incorporated into the crystal structure together to form a bond, and it should be understood that this case is also included within the chemical structure represented by Formula 1.

In some embodiments, the cathode active material may be a sodium-based active material or a potassium-based active material. For example, the secondary battery of the present disclosure may be provided as a sodium secondary battery or a potassium secondary battery. The sodium-based active material and/or the potassium-based active material may include a layered structure or a crystal structure in which Li of the above-described Formula 1 is substituted with Na and/or K.

In some embodiments, the cathode active material may be a calcium-based active material. For example, the secondary battery of the present disclosure may be provided as a calcium secondary battery. The calcium-based active material may include, for example, a calcium-cobalt active material and a calcium-phosphate active material, etc.

The conductive material may include a carbon-based conductive material such as graphite, carbon black, graphene, or carbon nanotubes and/or a metal-based conductive material such as tin, tin oxide, titanium oxide, or a perovskite material such as LaSrCoO₃, and LaSrMnO₃, etc. These may be included alone or in combination of two or more thereof.

The binder may include polyvinylidenefluoride (PVDF), poly(vinylidene fluoride-co-hexafluoropropylene) copolymer, polyacrylonitrile, polymethylmethacrylate, acrylonitrile butadiene rubber (NBR), polybutadiene rubber (BR), styrene-butadiene rubber (SBR), etc. In one embodiment, a PVDF-based binder may be used as the cathode binder.

The anode 200 may include an anode current collector 210 and an anode active material layer 220 disposed on at least one surface of the anode current collector 210. The anode active material layers 220 may be formed on both surfaces (e.g., upper and lower surfaces) of the anode current collector 210.

The anode current collector 210 may include gold, stainless steel, nickel, aluminum, titanium, copper or an alloy thereof, and may include, for example, copper or a copper alloy. In one embodiment, the anode current collector 210 may include copper subjected to surface treatment with carbon, nickel, titanium or silver.

The anode active material layer 220 may include an anode active material, a binder, and/or a conductive material. For example, an anode slurry including the anode active material, the binder, and/or the conductive material may be applied to the anode current collector 210 to form the anode active material layer 220.

The anode active material may include carbon-based materials such as crystalline carbon, amorphous carbon, a carbon composite, or carbon fiber; lithium metal; a lithium alloy; a silicon-containing material or tin-containing material, etc.

Examples of the amorphous carbon may include hard carbon, cokes, mesocarbon microbead (MCMB) calcined at 1500° C. or lower, mesophase pitch-based carbon fiber (MPCF) or the like. Examples of the crystalline carbon may include graphite-based carbon such as natural graphite, graphite cokes, graphite MCMB, graphite MPCF or the like. Other elements included in the lithium alloy may include, for example, aluminum, zinc, bismuth, cadmium, antimony, silicone, lead, tin, gallium, indium or the like. The silicon-containing material may include Si, SiOₓ (0<x<2), metal-doped SiOₓ (0<x<2), a silicon-carbon composite, etc. The metal-doped SiOₓ (0<x<2) may include a metal silicate, and the metal may include lithium and/or magnesium, etc.

As the binder and the conductive material, the materials described in the cathode 100 may be used. In one embodiment, as the binder for an anode, acrylonitrile butadiene rubber, polybutadiene rubber, styrene-butadiene rubber, etc. may be used, and the binder may further include a thickener such as carboxymethyl cellulose (CMC).

In some embodiments, the cathode active material layer 120 and/or the anode active material layer 220 may further include a solid electrolyte. Accordingly, the ionic conductivity of the cathode 100 and the anode 200 may be further improved.

An electrolyte layer 300 may be disposed between the cathode 100 and the anode 200. An electrode cell may be defined by the cathode 100, the electrolyte layer 300 and the anode 200. A plurality of the electrode cells may be sequentially stacked to form an electrode assembly. For example, the secondary battery may be provided as a solid-state battery.

The electrolyte layer 300 may include the electrolyte for a secondary battery according to the above-described embodiments. Accordingly, the ignition stability of the secondary battery may be enhanced, and the ionic conductivity, mechanical stability and durability may be improved.

In some embodiments, the electrolyte layer 300 may have a film or sheet shape.

According to exemplary embodiments, contact and short circuit between the cathode 100 and the anode 200 may be prevented by the electrolyte layer 300. Accordingly, the electrolyte layer 300 may be substantially provided as a separation membrane, and the secondary battery may not include a separation membrane such as a polymer film or non-woven fabric, etc.

In one embodiment, the secondary battery may further include a separation membrane. For example, the separation membrane may be interposed between the cathode 100 and the electrolyte layer 300, or between the anode 200 and the electrolyte layer 300. For example, the electrode assembly may be formed by winding, stacking, folding, and the like of the separation membrane.

The separation membrane may include a porous polymer film made of a polyolefin polymer such as ethylene homopolymer, propylene homopolymer, ethylene/butene copolymer, ethylene/hexene copolymer, ethylene/methacrylate copolymer. The separation membrane may include a nonwoven fabric made of glass fiber having a high melting point, polyethylene terephthalate fiber or the like.

In one embodiment, the lithium secondary battery may further include a non-aqueous electrolyte in which the cathode and the anode are impregnated.

The non-aqueous electrolyte may include a lithium salt and an organic solvent. As the organic solvent, for example, propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulforane, γ-butyrolactone, propylene sulfite, tetrahydrofurane, and the like may be used. These compounds may be used alone or in combination of two or more thereof.

The lithium salt may be selected from LiPF₆, LiClO₄, LiBF₄, LiFSI, LiTFSI, LiSO₃CF₃, LiBOB, LiFOB, LiDFOB, LiDFBP, LiTFOP, LiPO₂F₂, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiSCN, LiC(CF₃SO₂)₃ or a combination thereof.

Electrode tabs (a cathode tab and an anode tab) may protrude from the cathode current collector 110 and the anode current collector 210, respectively, and may extend to one side of a case of the secondary battery. The electrode tabs may be fused together with the one side of the case to form electrode leads (a cathode lead and an anode lead) that extending or exposed to an outside of the case.

The lithium secondary battery may be manufactured, for example, in a cylindrical shape using a can, a square shape, a pouch type or a coin shape.

Hereinafter, specific experimental examples are proposed to facilitate understanding of the present disclosure. However, the following examples are only given for illustrating the present disclosure and those skilled in the art will obviously understand that various alterations and modifications are possible within the scope and spirit of the present disclosure. Such alterations and modifications are duly included in the appended claims.

### EXPERIMENTAL EXAMPLE

### 1) Examples 1 to 8, and Comparative Examples 1 to 4

### (1) Preparation of Electrolyte for a Secondary Battery

Polyethersulfone (PES, Mw: 60,000 g·mol⁻¹ to 100,000 g·mol⁻¹) as an organic polymer, and inorganic particles were added to N-methyl-2-pyrrolidine (NMP) in the contents shown in Table 1 below, followed by stirring the same to prepare an electrolyte slurry. Two-dimensional hexagonal boron nitride (h-BN) particles having a length ranging from 50 nm to 400 nm was used as the inorganic particles.

In Table 1, the content of the organic polymer means a weight % of the organic polymer relative to a sum of the weight of the organic polymer and the weight of the inorganic particles included in the electrolyte for a secondary battery, and the content of the inorganic particles means a weight % of the inorganic particles to the sum of the weight of the organic polymer and the weight of the inorganic particles included in the electrolyte for a secondary battery.

The electrolyte slurries were applied to substrates (aluminum foils) and dried at a temperature of 80° C. to prepare electrolytes for a secondary battery of Examples 1 to 4 and Comparative Examples 1 to 4 in the form of a film having a thickness of about 20 m.

In Examples 5 to 8, electrolytes for a secondary battery were prepared in the same manner as in Examples 1 to 4, except that two-dimensional hexagonal boron nitride (h-BN) particles having a length ranging from 0.5 m to 2 m was used as the inorganic particles.

### (2) Evaluation of Thermal Stability

A thermal decomposition temperature of the electrolyte for a secondary battery was measured using a thermogravimetric analyzer (Q500, TA Instruments). Specifically, the electrolyte for a secondary battery was cut into a size of 3 mm×3 mm, then loaded into the thermogravimetric analyzer, and heated from room temperature to 700° C. at a rate of 5° C./min to measure a weight loss. The thermal decomposition temperature was calculated as a temperature at which the weight of the electrolyte for a secondary battery was reduced by 10% compared to the initially loaded weight.

Measurement results are shown in Table 1 below.

TABLE 1

| | | | Thermal |
|---|---|---|---|
| | Organic polymer | Inorganic particle | decomposition |
| Division | content (wt %) | content (wt %) | temperature (° C.) |
| Example 1 | 50 | 50 | 582 |
| Example 2 | 40 | 60 | 577 |
| Example 3 | 30 | 70 | 585 |
| Example 4 | 20 | 80 | 585 |
| Example 5 | 50 | 50 | 577 |
| Example 6 | 40 | 60 | 572 |
| Example 7 | 30 | 70 | 580 |
| Example 8 | 20 | 80 | 580 |
| Comparative Example 1 | 70 | 30 | 571 |
| Comparative Example 2 | 90 | 10 | 575 |
| Comparative Example 3 | 95 | 5 | 573.9 |
| Comparative Example 4 | 100 | 0 | 560 |

Referring to Table 1 above, in the case of the examples, the thermal stability of the electrolyte for a secondary battery was improved compared to the comparative examples.

In the case of the comparative examples, the thermal stability of the electrolyte for a secondary battery was reduced because the content of inorganic particles was less than 30 wt %, or the inorganic particles were not included.

### 2) Examples, and Comparative Examples 5 and 6

### (1) Preparation of Electrolyte for a Secondary Battery

Polyethersulfone (PES, Mw: 60,000 g·mol⁻¹ to 100,000 g·mol⁻¹) as an organic polymer, and inorganic particles were added to N-methyl-2-pyrrolidine (NMP) in the contents shown in Table 2 below, followed by stirring the same to prepare an electrolyte slurry. In Table 2 below, inorganic particles A are two-dimensional hexagonal boron nitride (h-BN) particles having a length ranging from 50 nm to 400 nm, and inorganic particles B are two-dimensional hexagonal boron nitride (h-BN) particles having a length ranging from 0.5 m to 2 m.

The electrolyte slurry was applied to a substrate (aluminum foil) and dried at a temperature of 80° C. to form an electrolyte for a secondary battery in the form of a film having a thickness of about 20 m.

### (2) Evaluation of Ionic Conductivity

Ionic conductivity of the electrolyte for a secondary battery was measured using an electrochemical impedance spectroscopy (EIS, VMP-300 Potentiostat). Specifically, the electrolyte for a secondary battery was cut into a circular film with a diameter of about 10 mm and a thickness of about 3 mm, and electrode terminals were contacted on upper and lower surfaces thereof, respectively. A resistance was measured by the AC impedance method at 25° C., 10 mV amplitude, and in the frequency range of 1 MHz to 100 MHz, and the ionic conductivity (S/cm) was calculated.

Measurement results are shown in Table 2 below. In Table 2, the content of the organic polymer means a weight % of the organic polymer relative to a sum of the weight of the organic polymer and the weight of the inorganic particles included in the electrolyte for a secondary battery, and the content of the inorganic particles means a weight % of the inorganic particles to the sum of the weight of the organic polymer and the weight of the inorganic particles included in the electrolyte for a secondary battery.

TABLE 2

| | Organic | Inorganic particle particles | | Ionic |
|---|---|---|---|---|
| | polymer | | Content | conductivity |
| Division | content (wt %) | Type | (wt %) | (S/cm) |
| Example 1 | 50 | A | 50 | 7.2 × 10⁻⁴ |
| Example 2 | 40 | A | 60 | 9.1 × 10⁻⁴ |
| Example 3 | 30 | A | 70 | 1.87 × 10⁻³ |
| Example 5 | 50 | B | 50 | 6.0 × 10⁻⁴ |
| Example 6 | 40 | B | 60 | 6.5 × 10⁻⁴ |
| Example 7 | 30 | B | 70 | 9.9 × 10⁻⁴ |
| Comparative Example 5 | 55 | A | 45 | 3.1 × 10⁻⁴ |
| Comparative Example 6 | 55 | B | 45 | 5.5 × 10⁻⁴ |

Referring to Table 2, the electrolyte for a secondary battery according to the examples had higher ionic conductivity than the comparative examples. In the examples, the electrolyte for a secondary battery containing relatively small inorganic particles had higher ionic conductivity.

In the comparative examples, the content of the inorganic particles was less than 50 wt %, and the ionic conductivity of the electrolyte for a secondary battery was reduced.

### 3) Example 1 and Comparative Example 7

An organic-inorganic film was prepared by coating the surface of a circular polyethylene (PE) substrate having a diameter of about 10 mm and a thickness of about 3 mm with TiO₂ particles having a particle diameter of 50 nm to 400 nm. Specifically, a composition including TiO₂ powder and PVdF was applied to the surface of the PE substrate and dried to form a coating layer having a thickness of about 20 m.

The film prepared in Example 1 and the organic-inorganic film prepared in Comparative Example 7 were each placed in a convection oven and left at a temperature of 120° C. for 20 minutes. The films were recovered from the convection oven, and the surfaces of the films were observed.

FIG. 2 is a photographic image obtained by photographing the surface of the electrolyte for a secondary battery according to Example 1. FIG. 3 is a photographic image obtained by photographing the surface of the organic-inorganic film according to Comparative Example 7.

Referring to FIG. 2 and FIG. 3, in Example 1, almost no wrinkle or indention was observed on the surface of the electrolyte film for a secondary battery. In the electrolyte film for a secondary battery of Example 1, no high-temperature shrinkage occurred. However, in Comparative Example 7, the organic-inorganic film shrank at a high temperature, and wrinkles and indentions were observed on the surface of the organic-inorganic film.

### DESCRIPTION OF REFERENCE NUMERALS

100: Cathode
110: Cathode current collector
120: Cathode active material layer
200: Anode
210: Anode current collector
220: Anode active material layer
300: Electrolyte layer

What is claimed is:

1. An electrolyte for a secondary battery comprising:
a polymer matrix; and
inorganic particles which contain boron and nitrogen, and have a two-dimensional shape,
wherein a content of the inorganic particles is a content of the polymer matrix or more based on the weight.

2. The electrolyte for a secondary battery according to claim 1, wherein the inorganic particles have a plate-like shape.

3. The electrolyte for a secondary battery according to claim 1, wherein the inorganic particles include boron nitride.

4. The electrolyte for a secondary battery according to claim 3, wherein the boron nitride has a hexagonal crystal structure.

5. The electrolyte for a secondary battery according to claim 1, wherein the inorganic particles have a length of 50 nm to 400 nm.

6. The electrolyte for a secondary battery according to claim 1, wherein the content of the inorganic particles is 50% by weight or more based on a total weight of the electrolyte for a secondary battery.

7. The electrolyte for a secondary battery according to claim 1, wherein the content of the inorganic particles is 60% by weight to 80% by weight based on the total weight of the electrolyte for a secondary battery.

8. The electrolyte for a secondary battery according to claim 1, wherein the polymer matrix comprises a fluorine resin or a sulfone resin.

9. The electrolyte for a secondary battery according to claim 1, wherein the content of the polymer matrix is 10% by weight to 50% by weight based on the total weight of the electrolyte for a secondary battery.

10. The electrolyte for a secondary battery according to claim 1, wherein the polymer matrix has a porous structure.

11. The electrolyte for a secondary battery according to claim 1, further comprising a liquid electrolyte impregnated in the polymer matrix.

12. The electrolyte for a secondary battery according to claim 11, wherein the liquid electrolyte comprises a lithium salt and an organic solvent.

13. The electrolyte for a secondary battery according to claim 1, further comprising a polymer of an acrylate monomer containing a phosphorus (P) atom or a fluorine (F) atom.

14. The electrolyte for a secondary battery according to claim 13, wherein the acrylate monomer comprises a phosphazene moiety.

15. A solid electrolyte layer comprising the electrolyte for a secondary battery according to claim 1.

16. The solid electrolyte layer according to claim 15, the solid electrolyte layer has a film shape or a sheet shape.

17. A secondary battery comprising:
a cathode;
an anode disposed to face the cathode; and
an electrolyte layer which is disposed between the cathode and the anode, and comprises the electrolyte for a secondary battery according to claim 1.
